(19) United States
(12) Patent Application Publication
(10) Pub. No.: US 2004/0181583 A1
(43) Pub. Date: Sep. 16, 2004

(54) Method of automatically connecting telephone to the internet via server for retrieving information

(75) Inventors: Cheng-Shing Lai, Taipei Hsien (TW); Liang Shen, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsien (TW)

(21) Appl. No.: 10/386,661

(22) Filed: Mar. 13, 2003

(51) Int. Cl. G06F 15/16

(52) U.S. Cl. 709/206; 709/203

(57) ABSTRACT

The present invention is to provide a method of automatically connecting an internet telephone to the Internet via a server for retrieving information including setting a program of the server in a memory of the internet telephone enabling a user to set an execution time, a telephone number to be dialed for accessing the Internet, and operating steps for viewing content through the program in order for a CPU of the internet telephone to perform the steps of counting time based on the execution time; dialing the telephone number set to access the Internet for connecting to the server; entering into a Web page via the server based on the operating steps; and downloading information from the Web page and storing the downloaded information in the memory.

### FIELD OF THE INVENTION

The present invention relates to telephones and more particularly to a method for enabling a person to automatically connect a telephone to the Internet via a server for retrieving information including stock market, weather forecast, or the like.

### BACKGROUND OF THE INVENTION

Over the past several decades there has been a simultaneous growth in technology and electronics and information and mobile communication products as well as expansion of the Web. Increasingly, more and more compact, multi-functional, and inexpensive telecommunication products are commercially available and popular. For example, internet telephones and PDAs (Personal Digital Assistants) are two of them closely related to our daily life and work. Their increasing popularity shortens time required for communicating between two distant users. In addition, people have an increasing demand to quality of telecommunication products as they are available in an even faster pace. Thus, a leading indicator of one telecommunication product can be decided based on whether it can provide a more convenient service, a more effective operation, and more features.

A current internet telephone enables a person to not only make a phone call but also retrieve information including messages, stock market, weather forecast, or the like from the Internet in an L-mode. In detail, for retrieving information from the Internet through the internet telephone a person must connect the telephone to a server (e.g., L-mode server) in advance. Once connected, the person is able to select a desired Web page for browsing information contained therein. For example, for browsing daily or monthly updated news such as stock market, weather forecast, or the like from the Internet a person must regularly operate a set of steps on telephone. In view of the above, it is tedious. Moreover, for persons (e.g., young or old persons in a family) not familiar with the Internet, such required steps for accessing the Internet are not convenient in operation.

Thus, it is desirable among telecommunication product manufacturers to provide a method for enabling a person to automatically connect an internet telephone to the Internet via a server for retrieving information.

### SUMMARY OF THE INVENTION

A primary object of the present invention is to provide a method of automatically connecting an internet telephone to the Internet via a server for retrieving information in order to overcome the above drawbacks of the prior art such as requisite regular accessing of the Internet and not suitable for persons unfamiliar with the Internet.

One aspect of the present invention is to provide a method of automatically connecting an internet telephone to the Internet via a server for retrieving information including setting a program of the server in a memory of the internet telephone and setting an execution time, a telephone number to be dialed for accessing the Internet, and operating steps for viewing content in the program, a CPU of the internet telephone performs the steps of counting time based on the set execution time in the program; in response to an equality of the incremented time to a predetermined time of execution, dialing the telephone number set to access the Internet for connecting to the server; entering into a Web page via the server based on the set operating steps; and downloading information from the Web page and storing the downloaded information in the memory. By utilizing the method, a user can obtain latest information from the Internet without regularly accessing the Internet. Hence, the invention is particularly adapted to enable persons not familiar with the Internet to retrieve information from the Internet.

The above and other objects, features and advantages of the present invention will become apparent from the following detailed description taken with the accompanying drawings.

### BRIEF DESCRIPTION OF THE DRAWINGS

FIG. 1 is a block diagram of an internet telephone according to the invention;

FIG. 2 is a flow chart illustrating a process of automatically connecting the telephone to the Internet via server according to the invention; and

FIG. 3 is another flow chart illustrating the process according to the invention.

### DETAILED DESCRIPTION OF THE PREFERRED EMBODIMENTS

The invention is directed to a method of automatically connecting an internet telephone to the Internet via a server for retrieving latest information such as stock market, weather forecast, etc. in order to overcome the above drawbacks of the prior art such as requisite regular accessing of the Internet or the like. The method includes enabling a user to set a program of the server (e.g., L-mode server) in a memory of the internet telephone (e.g., L-mode) and setting an execution time, a telephone number to be dialed for accessing the Internet, and operating steps for viewing content by running the program. Next, a CPU of the internet telephone performs the steps of counting time based on the set execution time in the program; in response to an equality of the incremented time to a predetermined time of execution, dialing the telephone number set to access the Internet for connecting to the server; entering into a Web page via the server based on the set operating steps; and downloading information from the Web page and storing the downloaded information in the memory.

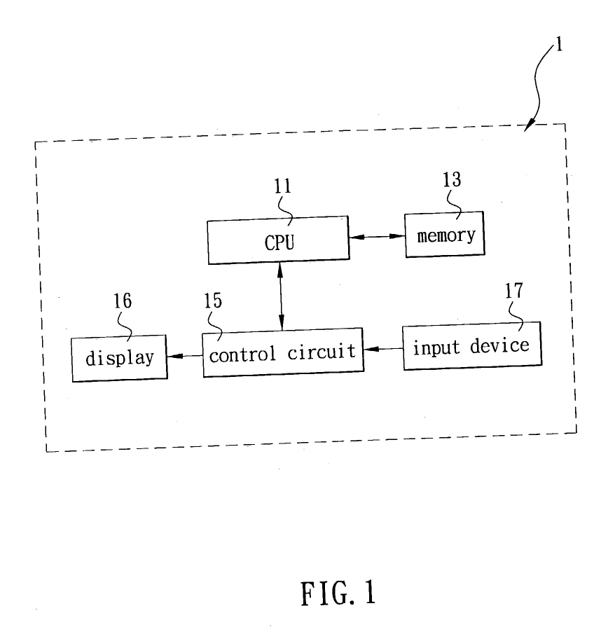

Referring to FIG. 1, there is shown an internet telephone 1 in accordance with the invention comprising a CPU (central processing unit) 11, a memory 13, a control circuit 15, a display (e.g., screen) 16, and an input device (e.g., keyboard, digital pen, or the like) 17. The CPU 11 is coupled to the memory 13. Hence, the CPU 11 can store data in the memory 13 or read data from the memory 13. The CPU 11 is further coupled to the control circuit 15 so that the control circuit 15 is able to send input data to the CPU 11 for processing. The control circuit 15 is coupled to the display 16 and the input device 17 respectively. As such, a user may set operating steps of program of the telephone 1 by means of the input device 17. As a result, the CPU 11 may perform a processing based on the operating steps and show the processed data on the display 16 for user viewing.

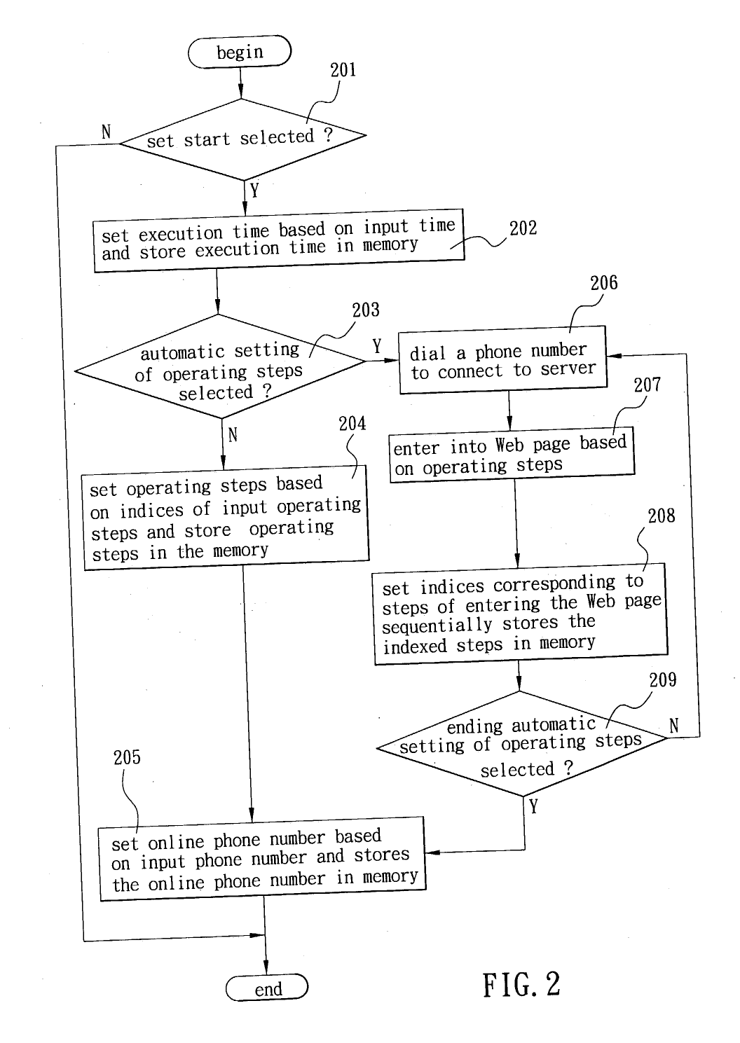

Referring to FIG. 2 in conjunction with FIG. 1, in the invention when a user performs the steps of setting execution time, telephone number to be dialed for accessing the Internet, and operating steps for viewing content by running a program on the telephone 1, the CPU 11 of the telephone 1 performs the following steps for setting execution time, telephone number to be dialed for accessing the Internet, and the operating steps.

Step 201, it is determined whether an option of setting start has been selected. If yes, the process goes to step 202. Otherwise, the process ends immediately.

Step 202, sets the execution time based on the input time and then stores the execution time in the memory 13.

Step 203, it is determined whether an option of automatic setting of operating steps has been selected. If yes, the process jumps to step 206. Otherwise, the process goes to step 204.

Step 204, sets operating steps based on the indices of the input operating steps and stores the set operating steps in the memory 13.

Step 205, sets telephone number to be dialed for accessing the Internet based on the input telephone number and stores the telephone number to be dialed in the memory 13. The process ends immediately.

Step 206, dials a user input telephone number to connect to a server such as L-mode server.

Step 207, enters into a desired Web page based on the operating steps performed by the user.

Step 208, sets indices corresponding to the steps of entering the Web page. Next, sequentially stores the indexed steps in the memory 13.

Step 209, it is determined whether an option of ending the automatic setting of operating steps has been selected. If yes, the loops back to step 205. Otherwise, the process loops back to step 206.

Referring to FIG. 2, in the invention index setting corresponding to the steps of entering the Web page is done based on the user operating steps. For example, an index “d2” is set if the user selects a second option of first menu of the server. Likewise, an index “d4” is set if the user selects a fourth option of second menu of the server. Further, the user inputs “025” in an unselected dialog box. As an end, an index of “d2d4025” is made.

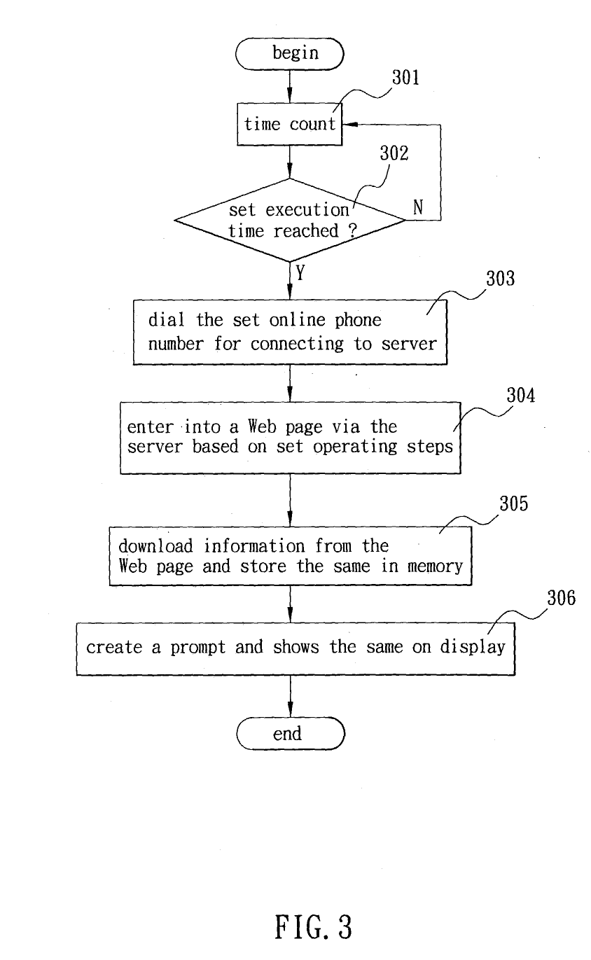

Referring to FIG. 3 in conjunction with FIG. 1, in the invention after a user has performed the steps of setting execution time, telephone number to be dialed for accessing the Internet, and operating steps for viewing content in the program, the CPU 11 of the telephone 1 performs the following steps:

Step 301, a time counting is started.

Step 302, it is determined whether the incremented time is equal to a predetermined time of execution. If yes, the process goes to step 303. Otherwise, the process loops back to step 301.

Step 303, dials the telephone number set to access the Internet for connecting to the server.

Step 304, enters into a desired Web page via the server based on the set operating steps performed by the user.

Step 305, downloads information from the Web page and stores the same in the memory 13.

Step 306, creates a prompt and shows the same on the display 16 so that the user can read the downloaded information. The process ends immediately.

In brief, by utilizing the method of automatically connecting telephone to the Internet via server for retrieving information according to the invention a user can obtain latest information such as stock market, weather forecast, or the like from the Internet without regularly accessing the Internet. Hence, the invention is particularly adapted to enable young or old persons not familiar with the Internet to retrieve information from the Internet.

While the invention has been described by means of specific embodiments, numerous modifications and variations could be made thereto by those skilled in the art without departing from the scope and spirit of the invention set forth in the claims.

What is claimed is:

1. A method of automatically connecting an Internet telephone to the Internet via a server for retrieving information including setting a program of the server in a memory of the internet telephone and setting an execution time, a telephone number to be dialed for accessing the Internet, and operating steps for viewing content in the program, a CPU of the internet telephone performs the steps of:
counting time based on the set execution time in the program;
in response to an equality of the incremented time to a predetermined time of execution, dialing the telephone number set to access the Internet for connecting to the server;
entering into a Web page via the server based on the set operating steps; and
downloading information from the Web page and storing the downloaded information in the memory.

2. The method of claim 1, wherein when setting the execution time, the telephone number to be dialed for accessing the Internet, and the operating steps for viewing content by running the program, for setting the execution time, the telephone number to be dialed for accessing the Internet, and the operating steps for viewing content the CPU of the internet telephone performs the steps of:
setting the execution time based on an input time and storing the execution time in the memory;
determining whether an option of automatic setting of the operating steps has been selected and if the determination is negative setting the operating steps based on indices of input operating steps and storing the set operating steps in the memory; and
setting the telephone number to be dialed for accessing the Internet based on the input telephone number and storing the telephone number to be dialed in the memory.

3. The method of claim 2, wherein while an option of automatic setting of the operating steps has been selected, the CPU of the internet telephone performs the steps of:
dialing the telephone number set to access the Internet for connecting to the server;
entering into a Web page via the server based on the operating steps; and
setting indices corresponding to the operating steps of entering the Web page and sequentially storing the indexed operating steps in the memory.
